(19) United States
(12) Patent Application Publication
(10) Pub. No.: US 2008/0245317 A1
(43) Pub. Date: Oct. 9, 2008

(54) Animal restraint and harness

(76) Inventor: Clinton R. Caldwell, Kalispell, MT (US)

Correspondence Address: JEAN KYLE, P. O. BOX 2274, HAMILTON, MT, 59840-4274, US

(21) Appl. No.: 12/079,687

(22) Filed: Mar. 28, 2008

Related U.S. Application Data
(60) Provisional application No. 60/920,484, filed on Mar. 28, 2007.

(51) Int. Cl. A01K 1/04; A01K 27/00

(52) U.S. Cl. 119/795; 119/856

(57) ABSTRACT

A pet restraint uses the animal's own weight to secure the animal to the restraint. The animal is rotatably tethered to a base and the tether is rotatably connected to the base. The tether is a length that keeps the animal on the base.

### CROSS-REFERENCE TO RELATED APPLICATIONS

This application claims the benefits of U.S. Provisional Application No. 60/920,484, filed Mar. 28, 2007, the disclosure of which is hereby incorporated by reference in its entirety including all figures, tables and drawings.

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Seatbelts save lives. It is estimated that of the nearly 40,000 traffic deaths each year, one half could have been prevented by seatbelts. Seatbelt use is required by law for human occupants in a majority of the states in the U.S. These laws however do not affect four legged passengers. Unrestrained pets in vehicles were the third leading cause of over one and one half million driver distracted accidents in 2007. Complicated pet beds (see for example, U.S. Pat. No. 4,597,359; U.S. Pat. No. 4,860,689; U.S. Pat. No. 5,123,377; U.S. Pat. No. 5,487,361; U.S. Pat. No. 5,685,258; U.S. Pat. No. 5,785,003; U.S. Pat. No. 6,374,771 B1; U.S. Design Pat. No. D461,966 S; U.S. Pat. No. 6,564,750 B1; U.S. Pat. No. 6,591,787 B1; and U.S. Pat. No. 7,204,205 B2) and pet restraints (U.S. Pat. No. 2,909,154; U.S. Pat. No. 3,310,034; U.S. Pat. No. 5,443,037; U.S. Pat. No. 5,666,909; U.S. Pat. No. 6,029,611; U.S. Pat. No. 6,543,390 B2; U.S. Pat. No. 6,601,540 B1; U.S. Pat. No. 6,834,621 B1; U.S. Pat. No. 7,021,245 B2) have been created for use in automobiles but none of these possess the versatility and ease of use to allow the them to be used on a variety of vehicles and in a variety of situations.

A need remains for a pet restraint that is versatile and easy to use. Ideally, the restraint could be mounted easily for use in or on a variety of vehicles including pickup trucks and motorcycles. Further, the restraint could be used with a simple pad, a bed or a basket. Finally, a truly versatile pet restraint would allow the device to be used apart from a vehicle to safely and securely restrain a pet or animal anywhere.

All patents, patent applications, provisional patent applications and publications referred to or cited herein, are incorporated by reference in their entirety to the extent they are not inconsistent with the teachings of the specification.

### BRIEF SUMMARY OF THE INVENTION

The invention is a pet restraint that safely secures a pet in a desired location. The restraint uses the weight of the pet to anchor the pet to a base. A tether to attach the pet to the base is rotatably connected to the base at one end. The other end of the tether rotatably connects to the pet. The length of the tether is such that the pet remains over the base and it is the pet's weight that prevents the base from moving. Preferably, a harness is used on the pet that allows the pet to be tethered to the base by its torso.

### BRIEF DESCRIPTION OF THE SEVERAL VIEWS OF THE DRAWING

FIG. 1 is a top perspective view of a preferred embodiment of the pet restraint of the subject invention.

FIG. 2 is a top plan view of a preferred embodiment of the pet restraint of the subject invention.

FIG. 3 is a side elevational view of a preferred embodiment of the pet restraint of the subject invention.

FIG. 4 is an environmental view of a pet restrained by a preferred embodiment of the pet restraint of the subject invention.

FIG. 5 is an environmental view of a pet restrained by a preferred embodiment of the pet restraint of the subject invention showing a preferred embodiment of the harness.

FIG. 6 is a side elevational view of another preferred embodiment of the pet restraint of the subject invention.

FIG. 7 is a side elevational view of another preferred embodiment of the pet restraint of the subject invention.

FIG. 8 is a top plan view of a preferred method of mounting a preferred embodiment of the pet restraint of the subject invention to a vehicle floor.

### DETAILED DESCRIPTION OF THE INVENTION

The subject invention involves a pet restraint wherein the pet is tethered to a base. The weight of the pet on that base restrains the animal.

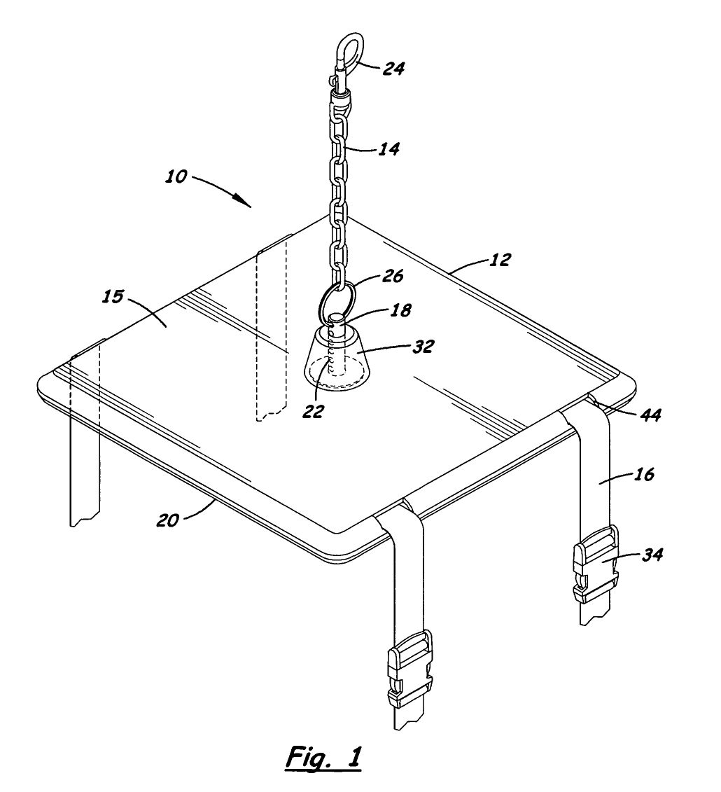

A preferred embodiment of the subject pet restraint is shown generally at 10 in FIG. 1. The restraint comprises a base 12 and a tether 14 to attach the base to an animal. The tether connects to the base and rotates relative to the base. Another rotatable connection attaches the tether to the animal.

The base 12 of the subject restraint can be any size. It is generally planar. In the exemplified embodiment, the restraint and base are configured for restraining a dog in a vehicle. In order to make the device applicable to most vehicles and useful with most dogs, the base is an approximate 10 inch by 10 inch square. It is noted however that the base size and shape can be adjusted for the restraint's intended use. For example, a large planar base several feet in diameter has been used successfully to restrain a horse. The base should be made of a resilient material that will not break or shatter under the weight of the restrained animal. In a preferred embodiment, the base is made from molded plastic. The plastic is strong yet lightweight. Further, plastic is generally non-marring and can be easily cleaned. In a particularly preferred embodiment, the base is a molded plastic shell with reinforcing ribs. A non-slip texture is formed on the top surface 15 of the base. The shell allows straps 16 to run through the base 12 to attach the base to another object, such as, a car's seat. One skilled in the art is aware of the many configurations a base can take based upon the need of the user and the materials chosen.

In the exemplified embodiment, a post 18 extends through the base 12 in approximately its center. The post rotates within the base and thus allows the tether 14 to be rotatably connected to the base. Preferably, the post is flush or recessed within the bottom surface 20 of the base so it does not mar a surface on which the base is placed or snag material should the base be place on a chair or car seat. In a preferred embodiment, the post 18 is a clevis pin. The clevis pin has apertures 22 along its length to allow versatility in configuring the restraint.

The tether 14 connects to the post 18. It is noted that in the exemplified embodiment, the post is positioned near the center of the base. This insures the tethered animal's weight will be on the base. One skilled in the art would recognize that the post and the tether can be positioned at other than near the center especially on irregularly shaped bases and still achieve the invention.

The tether 14 is a length that when attached to the animal being restrained keeps the animal's weight on the base. Preferably, where the animal is restricted to walking in a circle, standing sitting, and laying down. The appropriate length of the tether is effected by the shape of the base, positioning of the anchor on the base and attachment point of the tether to the animal.

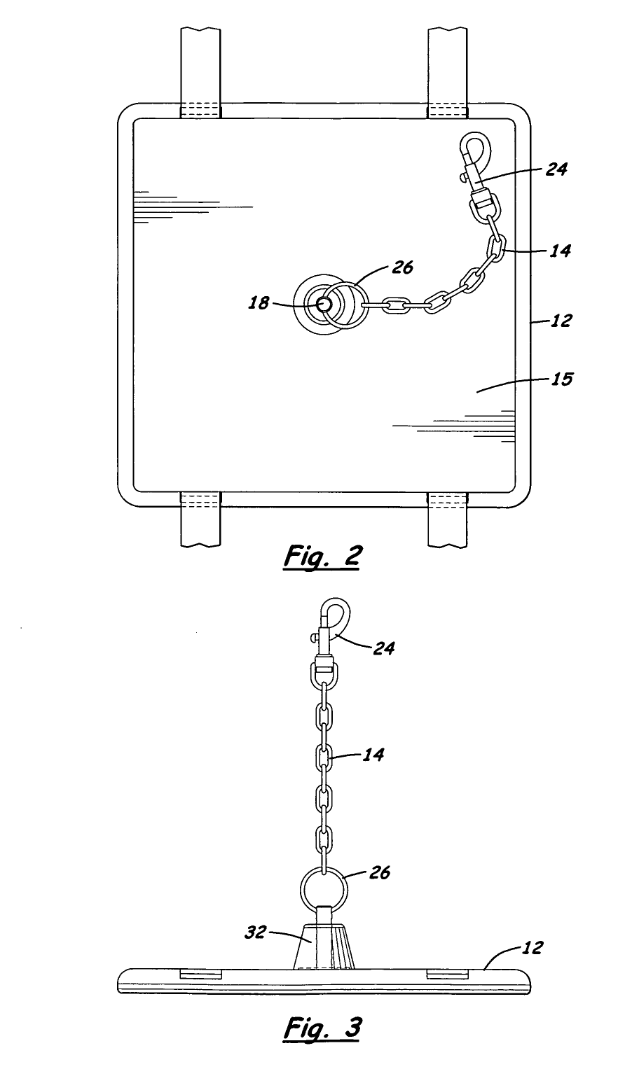

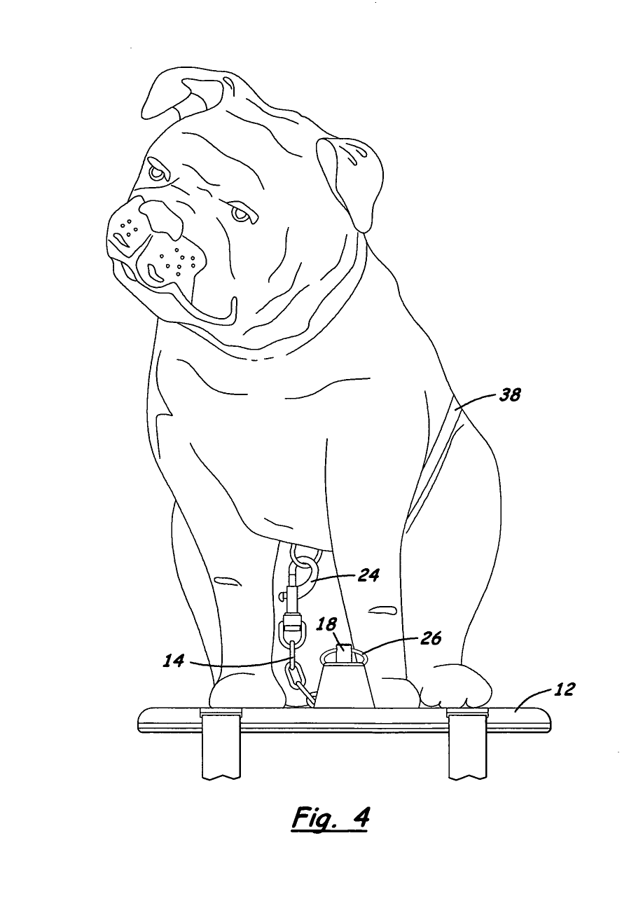

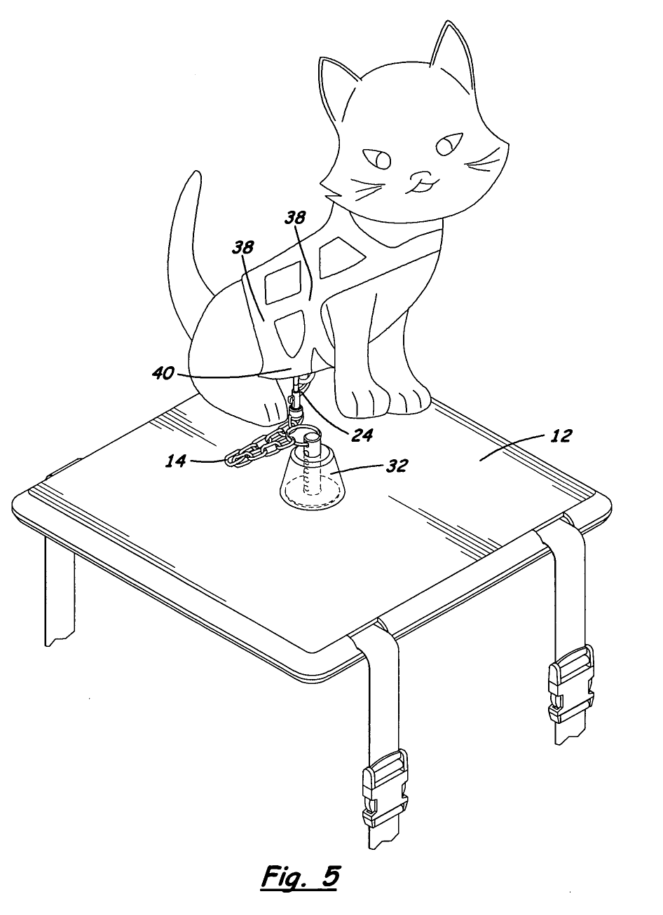

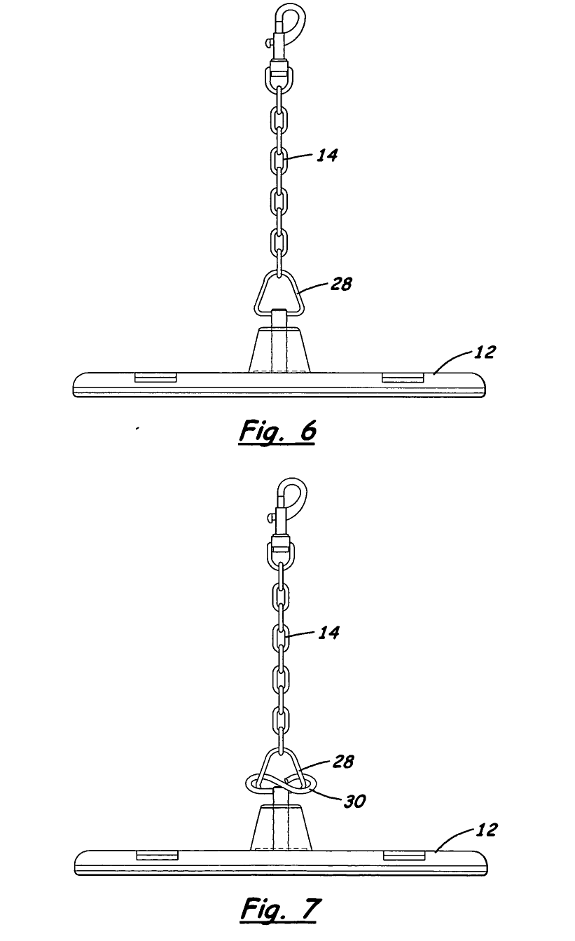

A rotatable connecting means 24 attaches the tether to the animal to be restrained. As noted, the exemplified embodiment is configured to restrain a dog in a vehicle. This embodiment has many features to make it useful for this purpose yet allow it to take many configurations and forms. The description of the fasteners and materials of the exemplified embodiment should not be restrictive however since it will be apparent to one skilled in the art the changes that can be made to fit other needs. For example, the tether 14 of the exemplified embodiment is dog link chain. Heavier chain could be used or alternatively the tether could be made of coated wire, rope or webbing. In the exemplified embodiment, the chain is attached to the clevis pin with a split ring 26 (see FIGS. 1-4). In other embodiments however (FIGS. 6 and 7) the split ring is replaced by a split D-ring 28 for strength. Additionally, an S hook 30 can be placed around the split D-ring 28 to further strengthen the connection when restraining larger animals. A swivel snap serves as the rotatable connecting means 24 to attach the tether to the animal being restrained. The swivel snap is reliable and can be quickly and easily released. One skilled in the art would realize however that other swiveling fasteners could be used.

It is important to note that the tether must be rotatably connected to the base and to the animal. These two points of rotation prevent the tether from being twisted which would, for example, cause the chain to bind. Further, rotation prevents the tether and its connectors from getting caught in the animals hair. When placed in or on a vehicle, with a tether length of only as long as the animal is tall, the two points of rotation allow the animal to position itself comfortably yet leaves room for limited slack should there be a sudden stop or accident and the animal is thrown.

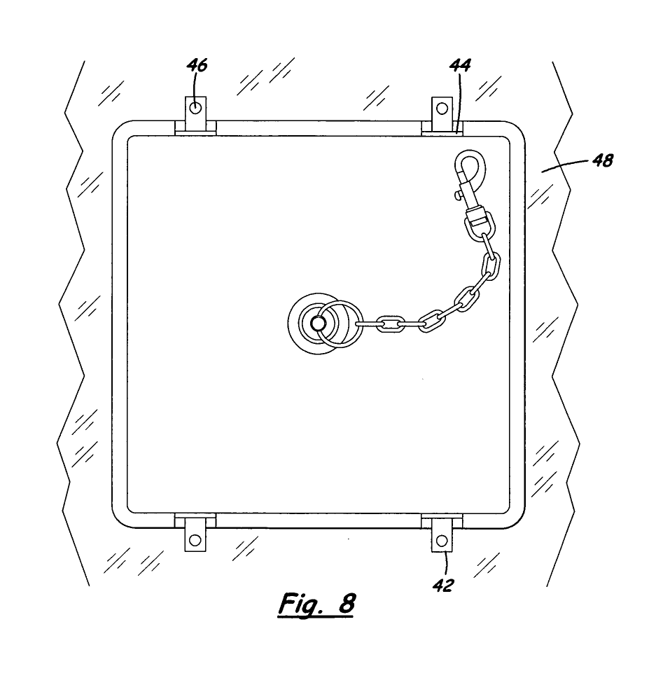

The pet restraint of the subject invention is versatile. In the exemplified embodiment, the restraint can be used alone or placed under a pad, in a basket, bed or crate with the tether protruding through the covering. The apertures 22 allow the split ring 26 to be placed anywhere along the post to accommodate varying cover depths. A cone 32 is provided to cover the post to prevent the post from causing discomfort to the animal. The straps 16 can be used to, for example, attach the device to a car seat. Buckles 34 on the straps allow for easy application and quick release. Alternatively, the base can be mounted to the floor of a vehicle. It can be bolted to the bed of a pickup or floor of a van or SUV. To avoid drilling into the vehicle itself, the base can be attached to, for example, a large piece of plywood as a support. Brackets can also be installed on the vehicle floor or support to hold the base. A preferred embodiment of means to permanently mount the base to a surface or support is shown in FIG. 8. In this embodiment, clamps 42 capture the vacant slots 44 for the straps and are bolted 46 to the support 48. In a particularly preferred embodiment, the clamps are coated to protect the base. The exemplified embodiment can be used to secure a pet onto or within a car, boat, van, bicycle, pickup, all terrain vehicle, motor home, wave runner, SUV or motorcycle. Further, the unit can be used alone or in conjunction with a pet's bed or basket to restrain the pet both indoors and outdoors.

An animal may be attached to the restraint of the subject invention with any harness or halter for non-vehicle use. The restraint of the subject invention however is preferably used with a harness that allows the animal to be attached to the restraint at its underside, particularly when used in or on a vehicle. A particularly preferred harness 36 is shown in FIG. 5. At least two straps 38 surround the torso of the animal and are joined by a ventral strap 40. A loop on the ventral strap provides an attachment point for the tether. Straps at the neck and/or chest, or along the back of the animal complete the harness. The subject harness applies force to the skeletal system as opposed to the soft tissue should the restrained animal experience a sudden jolt, for example, from be thrown in a car accident.

It is understood that the foregoing examples are merely illustrative of the present invention. Certain modifications of the articles and/or methods may be made and still achieve the objectives of the invention. Such modifications are contemplated as within the scope of the claimed invention.

I claim:

1. A restraint for an animal comprising:
a base comprising a top surface and a bottom surface;
a post extending through the base and rotatable therein; and
a tether connected to the post at one end and capable of being rotatably and releasably attached to the animal at the other end;
wherein the tether is a length that causes the animal to remain on the base and the animal is held by its own weight on the base.

2. The restraint of claim 1, further comprising a cover concealing a portion of said post extending from said top surface of said base.

3. The restraint of claim 1, wherein said tether is rotatably and releasably attached to said animal by a swivel snap.

4. The restraint of claim 1, wherein said post is a clevis pin.

5. The restraint of claim 1, further comprising at least one strap on said base to attach said base to a structure.

6. The restraint of claim 5, wherein said at least one strap is through a slot in said base.

7. The restraint of claim 1, further comprising at least one clamp to attach said base to a structure.

8. The restraint of claim 7, wherein said at least one clamp is through a slot in said base.

9. The restraint of claim 1, wherein said post is about flush with said bottom surface of said base to prevent damaging a surface on which said base is placed.

10. The restraint of claim 1, wherein said post extends through about the center of said base.

11. A harness for an animal comprising:
at least two straps around the torso of the animal; and
a ventral strap connecting the at least two torso straps.

12. The harness of claim 11, further comprising a dorsal strap connecting said at least two torso straps.

13. The harness of claim 11, further comprising a chest strap connecting said at least two torso straps.

14. The harness of claim 11, further comprising a collar associated with said at least two torso straps.

15. The harness of claim 11, further comprising a means to attach a tether to said animal on said ventral strap.

16. A restraint for an animal comprising:
a base comprising a top surface and a bottom surface;
a post extending through the base and rotatable therein; and
a tether connected to the post at one end and capable of being rotatably and releasably attached to the animal at the other end;
wherein said animal is attached to said tether by a harness comprising at least two straps around the torso of the animal, and a ventral strap connecting the at least two torso straps; and wherein the tether is a length that causes the animal to remain on the base and the animal is held by its own weight on the base.
